(19) United States
(12) Patent Application Publication
(10) Pub. No.: US 2011/0020644 A1
(43) Pub. Date: Jan. 27, 2011

(54) PELLETS OF CELLULOSIC SPUN FIBERS, THEIR PRODUCTION AND USE

(76) Inventors: Friedrich Suchomel, Schorfling (AT); Christoph Burgstaller, Wels (AT); Wolfgang Stadlbauer, Breitenaich (AT)

Correspondence Address: FITZPATRICK CELLA HARPER & SCINTO, 1290 Avenue of the Americas, NEW YORK, NY, 10104-3800, US

(21) Appl. No.: 12/809,196

(22) PCT Filed: Dec. 18, 2008
(86) PCT No.: PCT/AT08/00461

§ 371 Date: Oct. 15, 2010

(30) Foreign Application Priority Data
Dec. 21, 2007 (AT) A 2103/2007

(51) Int. Cl. D02G 3/22; B29C 67/00; B32B 37/12; B32B 37/10

(52) U.S. Cl. 428/359; 264/297.1; 156/242

(57) ABSTRACT

The present invention relates to readily meterable pellets of cellulosic staple fibers, their use to produce compound materials by mixing these into a polymer melt and a process for the production of these pellets in which the staple fibers are pressed in a shaping device through shaping channels.

### BACKGROUND OF THE INVENTION

1. Field of the Invention

The invention relates to easily metered moulded bodies of cellulosic fibers, their production and use for the production of compound materials by metering the cellulosic fibers in melts, in particular using mixing units.

2. Description of Related Art

Cellulosic fibers are being used to an increasing extent to reinforce matrix materials such as polypropylene or other polymers in compound materials where they for example replace glass fibers. The advantages of cellulosic fibers compared to glass fibers lie in their low specific weight and in their improved disposability since they can for example be easily burned with the matrix material or decomposed in the case of bio-degradable matrix materials.

Suitable cellulosic materials can be produced in different ways. The simplest way is the use of cotton and other natural fibers such as hank or flax which are already naturally in the form of fibers. What is however problematic is the irregularity of the fibers which is common to natural products with regard to the thickness, length and surface structure. These irregularities lead to more laborious processing. Thus for example they have to be cut to an even length as the case may be. Apart from cotton, the natural fibers are too coarse for high performance compound materials so that there is no regular distribution in the matrix material and no sufficient surface between the fiber and the matrix. In addition many of the natural fibers tend to yellow strongly or emit an unpleasant smell.

Likewise it is possible to use pulp fibers which are made from wood in the well known way using pulping processes. Commonly available pulps are, however, pressed into sheets and rolls and dried after production. It is subsequently very difficult to disintegrate the individual fibers from the pressed sheet. In addition the purity of the pulp depends on the type of cooking and on whether paper or chemical pulp was used. This in turn influences the tenacities of both the individual fiber as well as of the finished compound material. Lignin as an accompanying material in particular in cheap pulps is disturbing since a compound material produced in this way can turn dark-brown. Moreover the lignin precipitates, which in thermal terms is only stable in the deformation process up to 150° C., and leads to emissions which excludes these compound materials from many applications e.g. in automobile interiors.

Better defined cellulosic man-made fibers with enhanced properties and adjusted to the application can be produced, such as viscose or Lyocell, using what are also well-known spinning processes.

The cellulosic fibers are normally introduced to an extruder via a metering screw where they are mixed with polymer. Due to the good fiber-fiber adhesion, the individual fiber are however not readily pourable and this can lead to for example the so-called formation of bridges in the metering funnel of the metering screw and to subsequent blockages. As a result the fibers can only be metered in a very irregular manner which in turn leads to considerable quality fluctuations in the fiber-reinforced polymer.

Thus there have already been attempts to improve the metering ability of these cellulosic fibers. WO 2006/032406 for example describes the treatment of a spinning fiber tow with an aqueous dispersion to apply a size. The size helps to promote the coherence of the individual fibers. This tow containing size is then broken down into pourable fiber bunches. This process has the disadvantage that with the fiber bunches an additional substance, namely the size, is introduced into the compounds materials. Here it can influence the mechanical properties, in particular the fiber-matrix interactions, which are important for the efficiency of the fiber reinforcement, quite considerably and to an undesired extent. In addition the process in WO 2006/032406 demands extensive intervention directly at the spinning machine such as for example the application and drying of the size or the bringing together and twisting of several spinning fiber tows in front of the cutting machine. As a result of the twisting, the willingness to open of the bunches deteriorates.

Likewise a well known surface coating of the fibers serves to reduce the fiber-fiber adhesion. To this end the fibers are coated with a finishing agent which increases the gliding effect, mostly a silicone oil. These finished fibers can in fact be more easily metered out than non-finished ones but which are otherwise comparable and they can also be more readily distributed in the matrix-polymer. However, this finishing agent can also have a negative effect on the fiber-matrix interactions and must, therefore, be specially adjusted to this application. Moreover other disadvantages of individual short fibers remain such as for example the dust-like flying when pouring, the low bulk density etc.

EP 1436130 and WO 03/01611 reveal so-called pultrusion processes in which a spinning fiber tow first of all emerges together with the matrix polymer through a die opening, thereby being coated with the matrix polymer and the solidified tow is finally reduced to granules which should be readily meterable. These pultrusion processes demand the early fixing on the matrix polymer, to which the cellulosic fiber is to be added, in addition to the considerable complexity of the pultrusion unit.

Another variant for the production of easily meterable granules, which contain both reinforcement fibers as well as a thermoplastic matrix polymer, is described in EP 1097033. In this respect a tow which contains both the reinforcement fiber material, for example cellulosic or also mineral fibers as well as the matrix polymer likewise in the form of endless filaments, is drawn through a heated opening so that the matrix filaments (partly) melt and the reinforcement fibers are integrated in the melted mass. At the same time the fiber tow is twisted when pulling it through so that the reinforcement fibers are present in a spiral shape in the tow which is subsequently cut to granules. This spiral-shaped position means that the reinforcement fibers have a longer length than the individual granule parts themselves. This process should be more favourable in energetic terms compared to the simple pultrusion process, otherwise it has the same principle disadvantages as described above.

### SUMMARY OF THE INVENTION

The task of the present invention was, therefore, to make cellulosic fibers available in a way that the cellulosic fibers are easier to meter than in comparison to the well-known state of the art of technology and at the same time the reinforcement properties of these fibers are improved in the compound material without introducing larger quantities of undesired additives into the compound material.

Surprisingly this task could be solved by moulded bodies, so-called pellets, of cellulosic spinning fibers whereby the spinning fibers have a titer in the range of 0.1 to 15.0 dtex and a cut length in the range of 0.5 to 15.0 mm and the pellets a diameter of 2.0 to 10.0 mm.

The length of the pellets is not decisive for the success of the invention. In the process described below for the production of pellets, these are mostly generated in a length of 1.0-30.0 mm. Since they are not held together by a binder or size, they can even break into rods of a shorter length without this impairing the future metering ability.

### BRIEF DESCRIPTION OF THE DRAWINGS

For a better understanding of the present invention, reference is made to the following drawings. Referring to the drawings:

FIG. 1 shows the result of tensile strength tests for E-module for an exemplary embodiment of pellets made in accordance with the invention.

FIG. 2 shows the results of tensile strength tests for maximum elongation for an exemplary embodiment of pellets made in accordance with the invention; and

FIG. 3 shows the results of impact bending tests for an exemplary embodiment of pellets made in accordance with the invention.

### DETAIL DESCRIPTION OF THE INVENTION

The spinning fibers can be covered with a gliding finishing agent prior to pressing. In this respect attention is to be paid to the lowest possible content of finishing agent so as to influence the subsequent compound material properties to the lowest extent as described above. In general a finishing agent content of 1%, in relation to the overall mass of the dry, finished fibers, should not be exceeded. Moreover the type of gliding finishing agent is geared towards the respective matrix polymers foreseen. Thus for example a nonpolar finishing agent is very well suited to the use in nonpolar thermoplastic matrix polymers. Surprisingly the pellets in accordance with the invention can be produced from the spinning fibers treated with a gliding finishing agent which do not immediately decay despite the gliding finishing agent.

The stability of the pellets can, if desired, be increased in particular by adding around 0.01 to 5 weight percentage of a common hotmelt adhesive to the fibers. The hotmelt adhesive can be mixed with the fibers in powder form before pelletizing. In the subsequent compound material, these small amounts of hotmelt adhesive do not, in our experience, have a negative impact.

For special applications a share of a polymer and/or one or several other additives such as adhesive agents can be added already when producing the pellets. MAPP (maleic acid hydride-grafted polypropylene) is suitable as an adhesive agent between the cellulose and the polypropylene. Other examples for possible additives are all the additives common in plastic processing such as stabilizing agents, dyestuffs, UV protection agents, pigments and property enhancers such as impact resistance modifiers.

Mainly the invention is geared towards pellets which do not yet contain a share of matrix polymer.

The object of the present invention is also a process for the production of pellets of cellulosic spinning fibers which can be more easily metered out in comparison to the well known state of the art and at the same time improve the reinforcement properties of these fibers in the compound material.

This process involves cellulosic spinning fibers with a titer in the range of 0.1 to 15.0 dtex and a cut length in the range of 0.5 to 15.0 mm being pressed into a shaping device through shaping channels. An important characteristic of the process in accordance with the invention is the L/D ratio of these shaping channels. It should equal between 1:1 and 4:1 and preferably between 1:1 and 3:1 whereby L is the length and D the diameter of the cylindrical part of a shaping channel without an inlet and relief cone. This L/D ratio quite considerably influences the compacting which the spinning fibers experience in the pellet. This has an effect on the re-disintegratability of the pellets and on the fiber damage which occurs during pressing. The pellets received reveal a diameter of 2.0 to 10.0 mm and a length of at least 1.0-30.0 mm.

The cellulosic staple fibers can be spun according to each of the usual processes known for this. Following the respective coagulation, washing and potentially other post-treatment steps which are required, the fiber tow is cut to the length desired using the staple fiber cutting machines known to the expert and dried to the required moisture content. Depending on the conditions on the site, the fibers are dried to a low moisture content for example for transportation and then wetted again to the necessary value prior to pressing, for example by spraying. Depending upon the requirements, a gliding finishing agent is applied to the fibers.

Preferably the cellulosic spinning fibers are produced using the Viscose, Modal or Lyocell process. Likewise blends of at least two of these types of fibers can be processed together to pellets.

To keep the damage to the spinning fibers low and the re-disintegratability when mixing into the matrix polymer high, a moisture level of 30 to 80 weight percentage water is to be set in the fibers prior to the pelletizing procedure. The water is only used to produce the pellets. It serves so to speak as a softener for the fibers. The water partly dries up again during the pelletizing procedure which develops heat as a result of the mechanical forces which take effect and the friction. The pellets are finally dried again to the conditioning moistness level.

If the fibers were equipped with a gliding finishing agent prior to the pelletizing procedure, in particular with silicone oil, a dampening of this kind is not necessary since the finishing agent keeps the fiber damage low and the re-disintegratability high.

The short-cut fibers can be metered in to the shaping unit with a metering unit working in a coarse manner and the precision and regularity of which would not be suitable for the production of compound materials but which is not sensitive when it comes to blockages by the fibers. For example a flat matrix press is suitable as a shaping unit whereby the fibers are pressed through a matrix using a panmill i.e., a panel with regularly arranged shaping channels.

In a flat matrix press of this kind the pelletized fibers are placed in the pressing room and form a material layer on the matrix. The fiber layer is pre-compressed by the rolls of the panmill and pressed into the shaping channels. In these shaping channels, the compressing to pellets takes place. The distance between the rolls of the panmill and the matrix should be adjustable to allow the adjustment to different fibers and the evening out of the material wear. The fibers are further compressed in the shaping channels and formed to cylindrical tows which emerge below the matrix. Here the tow is cut to the desired length via a rotating knife and the pellets obtained emerge from the shaping device.

To produce larger quantities of the pellets in accordance with the invention, a so-called ring matrix press is even better suited than the flat matrix press.

The pellets emerging from the shaping device can be metered into a melt extruder directly or following suitable intermediate storage, transportation etc. using well-known metering devices for granules etc. where they are mixed with the respective matrix polymer. As a result of the shearing forces which occur in an extruder of this kind, the pellets are quickly completely fragmented and the individual fibers can be distributed very homogeneously in the matrix polymer through this.

An additional advantage of the present invention resides in the low amount of individual fibers required to obtain the same mechanical properties due to the good distribution of the individual fibers in the matrix polymers.

Another object of the present invention is, therefore, the use of pellets produced according to the invention for the production of compound materials by mixing into a polymer melt. This mixing in is preferably performed in a correspondingly equipped extruder or kneader. Suitable apparatuses for this and suitable metering units are known to the specialist. Metering units working in a gravimetric manner are particularly well suited as well as devices designed for granules such as for example gravimetric screw metering devices.

In the following, the invention is described using an example. The invention is, however, expressly not restricted to this example but rather comprises all the other design variants which are based on the same inventive concept.

### EXAMPLES

### Example 1

### Comparative Example

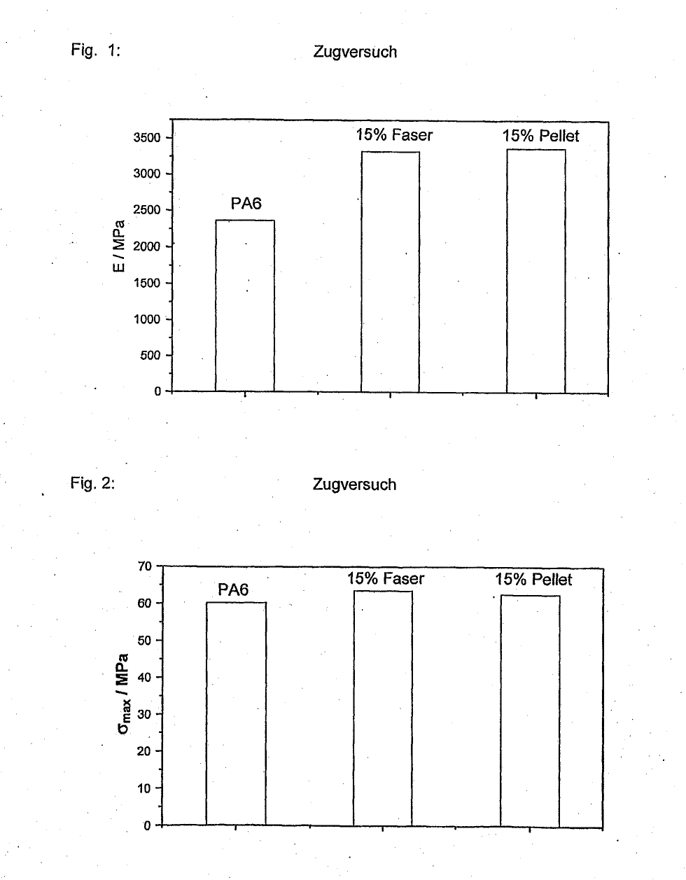

Lyocell fibers with a titer of 2.8 dtex were spun in the well-known way and, in the form of the fiber tow, washed, post treated, treated with a standard textile finishing agent and dried. In the dried condition only, these fibers were cut with a guillotine cutting machine to a staple length of 5 mm. In this way so-called staples were obtained. These are fiber bundles which are pressed at the cut surfaces through the cutting machine so far that there is a certain cohesion among the individual fibers. It was less easy to meter out these staples than the pellets produced according to the invention but a metering was all the same basically possible using the test device in use. These staples were therefore metered into the melt extruder without any intermediate pressing with test conditions which were otherwise the same and the test bodies were produced for tensile tests. Table 1 and FIGS. 1-3 show the measuring results (“fiber”).

This comparative test without pelletizing was performed in a test line to be able to make a quantitative comparison with regard to for example fiber damage through the process according to the invention. It must be expressly emphasized that these fiber staples are not suitable for large-scale processing in the plastics industry since for example the metering does not take place via the normal standard screws and is strongly restricted in the throughput due to the low bulk density of the fibers. The metering of these fiber staples cannot be performed in gravimetric terms so that it is necessary to work with a constant metering screw speed and thus an inherent irregularity of the metering. This type of metering is therefore not really practicable which excludes its implementation in the plastics industry.

### Example 2

As in example 1, Lyocell fibers were spun with a titer of 2.8 dtex and staples with a length of 5 mm were produced.

The staples were wetted to a water content of 50% by spraying with water, by hand they were filled into a flat matrix press from the manufacturer Amandus Kahl, Hamburg, where they were formed to pellets. The matrix panel of this shaping device revealed 240 shaping devices with a diameter of 4 mm and an L/D ratio of 1.5:/1. In accordance with this, pellets with a diameter of 4 mm and a length of between 2 mm and 6 mm were obtained.

These pellets were metered into a double screw extruder (Thermo Prism TSE24HC) using a gravimetric two screw dosing device (type Process Control, granule screw d=20 mm) and there they were mixed at a maximum temperature of 220° C. with a throughput of 10 kg/h and at a screw speed of 400 rpm with polyamide-6 (type Durethan B30S from Lanxess) previously melted down as granules. The ratio equalled 15 weight percent of pure cellulose (pre-dried cellulose, max. 2% water content) to 85 weight percent of polyamide. From the compound material obtained, universal testing bodies (ISO-3167) were obtained using die casting for tensile tests (ISO-527) and impact bending tests (ISO-179). Table 1 and FIGS. 1-3 show the measuring results for the tensile and impact bending tests (“pellets”).

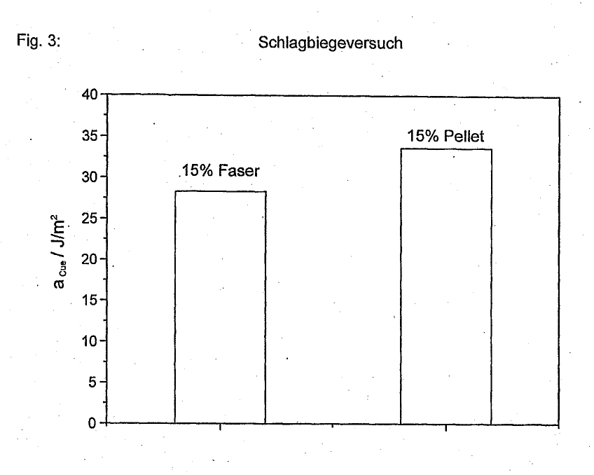

The test results show clearly that the pelletizing of the fibers has no considerable influence on the properties of the fibers in the compound (E-module, maximum elongation) i.e. in particular no noticeable damage to the fibers. The slight difference in the strength lies below 2% and is thus negligible. The higher impact resistance in the compound materials from the pellets is striking which can be explained by the regular distribution of the fibers in the matrix polymer. In comparison the values for a test body from the purely PA-6 of examples 1 and 2 are included in the diagrams for tensile strengths (FIG. 1 and FIG. 2). In the impact bending test, PA-6 does not break without notches. For this reason no value is given in this diagram (FIG. 3) for pure PA-6.

Other tests with pellets with a length of 12 mm and a diameter of 8 mm, i.e. likewise an L/D ratio of 1.5:/1 which were likewise made in a flat matrix press, produced comparable results.

To sum up one can say that the pelletizing using the flat matrix press alleviates processing since these pellets can be readily processed with standard equipment in the plastics industry whereby a process optimization is possible with regard to the economic efficiency (maximum throughput) and product quality.

TABLE 1

| | | | σMax/ | | aCue/ |
|---|---|---|---|---|---|
| Cellulose | PA6 | E/MPa | MPa | ε/% | kJ/m² |
| 15 wt % | 85 wt % | 3322 | 63.54 | 4.56 | 28.29 |
| Fiber | | | | | |
| 15 wt % | 85 wt % | 3368 | 62.53 | 4.74 | 33.63 |
| Pellet | | | | | |
| 0 wt % | 100 wt % | 2357 | 60.29 | 16.9 | — |

What is claimed is:

1. Pellets of cellulosic staple fibers wherein the staple fibers have a titer in the range of about 0.1 to about 15.0 dtex and a cutting length in the range of about 0.5 to about 15.0 mm and the pellet has a diameter of about 2.0 to about 10.0 mm.

2. The pellets according to claim 1, wherein the staple fibers comprise a gliding finishing agent.

3. The pellets according to claim 1 or 2, wherein the staple fibers are selected from the group consisting of Lyocell, Viscose fibers, Modal fibers and a blend of at least two of these fiber types.

4. The pellets according to claim 1, 2 or 3, further comprising between about 0.01 and about 5.0 weight percent of hotmelt adhesive.

5. A process for the production of pellets of cellulosic staple fibers comprising pressing the cellulosic staple fibers having a titer in the range of about 0.1 to about 15.0 dtex and a cutting length in the range of about 0.5 to about 15.0 mm in a shaping device through shaping channels.

6. The process according to claim 5, wherein the L/D ratio of the shaping channels equals between about 1:1 and about 4:1; preferably between about 1:1 and about 3:1.

7. The process according to claim 5, wherein the shaping device is a flat matrix press or a ring matrix press.

8. The process according to claim 5, wherein the staple fibers are brought to a humidity of about 30 to about 80 weight percent of water prior to pressing.

9. The process according to claim 5, wherein the staple fibers are mixed with about 0.01 to about 5.0 weight percentage powder-form hotmelt adhesive prior to pressing.

10. Use of pellets according to claim 1, 2, 3 or 4 for the production of compound materials by mixing the pellets into a polymer melt.

11. The use according to claim 10, wherein the mixing takes place in an extruder.

12. The use according to claim 10, wherein the mixing takes place in a kneader.
